(19) United States
(12) Patent Application Publication
(10) Pub. No.: US 2009/0251609 A1
(43) Pub. Date: Oct. 8, 2009

(54) System and method for determining a mode of viewing a display and adapting displayed elements to the mode of viewing

(75) Inventor: Timothy Almeida, Corona, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/080,296

(22) Filed: Apr. 2, 2008

(51) Int. Cl. G06F 12/10

(52) U.S. Cl. 348/569

(57) ABSTRACT

A method of displaying information on a video display monitor is disclosed, and comprises receiving a command to display an on-screen display (OSD) menu, determining an origin of the command to display the OSD menu, if the command originated from an actuation of a control on the video display monitor, then generating and displaying a first OSD menu, and if the command originated from an actuation of a control on a remote control device, then generating and displaying a second OSD menu. The first OSD menu and the second OSD menu are different.

### BACKGROUND OF THE INVENTION

1. Field of the Invention

The present invention relates to video displays, and more particularly pertains to a new method and apparatus for determining a mode of viewing of a display by a user and automatically adapting elements displayed on the screen of the display for the mode of viewing by the user.

2. Description of the Prior Art

The increasing availability of video displays with thinner cabinet depths and larger screen sizes has made the use of the same video display for both an entertainment display (for showing, e.g., television programs and prerecorded movies) and a computer display increasingly common. In these different roles, the viewer of the display usually views the display at different distances. For example, when used for displaying computer applications such as word processing programs, the user is typically positioned about a meter or less from the screen of the display. In contrast, when used for viewing an entertainment program, the user is typically positioned about two to three meters from the screen.

These diverse uses of a video display can present some challenges in allowing the display to be operated as easily in both modes of viewing. For example, icons, text and graphics that are displayed in a manner suitable for use at a distance of about one meter are typically too small for comfortable viewing at a distance of two to three meters, and conversely the same elements displayed at a size suitable for viewing at a distance of two to three meters are typically too large for useful viewing at a distance of less that one meter.

One situation where this dichotomy presents itself is in the display of menus, such as on-screen display (OSD) menus used to control the display settings of the display. Viewing the display at different distances for different purposes (such as entertainment versus computer display) may require using different display settings, so switching between the types of use may require accessing the OSD menu each time the mode of use is changed.

It is therefore believed that there exists in the art a need for a system that facilitates the viewing of menus on a display at different distances by automatically adjusting the character of the icons, text and graphics depending upon the mode of viewing of the display by the viewer.

### SUMMARY OF THE INVENTION

The present invention provides a new apparatus for determining a mode of viewing of a display by a user and automatically adapting elements displayed on the screen of the display for the mode of viewing by the user.

In one aspect, a method of displaying information on a video display monitor is disclosed. The method comprises receiving a command to display an on-screen display (OSD) menu, and determining an origin of the command to display the OSD menu. If the command originated from an actuation of a control on the video display monitor, then a first OSD menu may be generated and displayed. If the command originated from an actuation of a control on a remote control device, then a second OSD menu may be generated and displayed. The first OSD menu and the second OSD menu are different.

In another aspect, a system for displaying information on a video display monitor is disclosed. The system may comprise a video display monitor including a display screen, a memory configured to store firmware instructions, and a processor for executing the firmware instructions. The system may also comprise a set of instructions stored on the memory and configured to cause the processor to receive a command to display an on-screen display (OSD) menu, determine an origin of the command to display the OSD menu. If the command originated from an actuation of a control on the video display monitor, a first OSD menu is then generated and displayed. If the command originated from an actuation of a control on a remote control device, then a second OSD menu is generated and displayed. The first OSD menu and the second OSD menu are different.

This is a general outline of the more important aspects and features of the invention, and the detailed description of this application that follows discloses additional features of the invention which form the subject matter of the claims appended hereto.

Further features and advantages of the invention which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagrammatic view of one embodiment of a system for determining a mode of viewing a display and adapting displayed elements to the mode of viewing.

FIG. 2 is a schematic diagrammatic view of another embodiment of a system for determining a mode of viewing a display and adapting displayed elements to the mode of viewing.

FIG. 3 is a schematic flow diagram of a method for determining a mode of viewing a display and adapting displayed elements to the mode of viewing.

FIG. 4 is a schematic view of the configuration of a first OSD menu of the present disclosure.

FIG. 5 is a schematic view of the configuration of a second OSD menu of the present disclosure.

FIG. 6 is a schematic view of the configuration of a first OSD menu of the present disclosure.

FIG. 7 is a schematic view of the configuration of a second OSD menu of the present disclosure.

### DESCRIPTION OF PREFERRED EMBODIMENTS

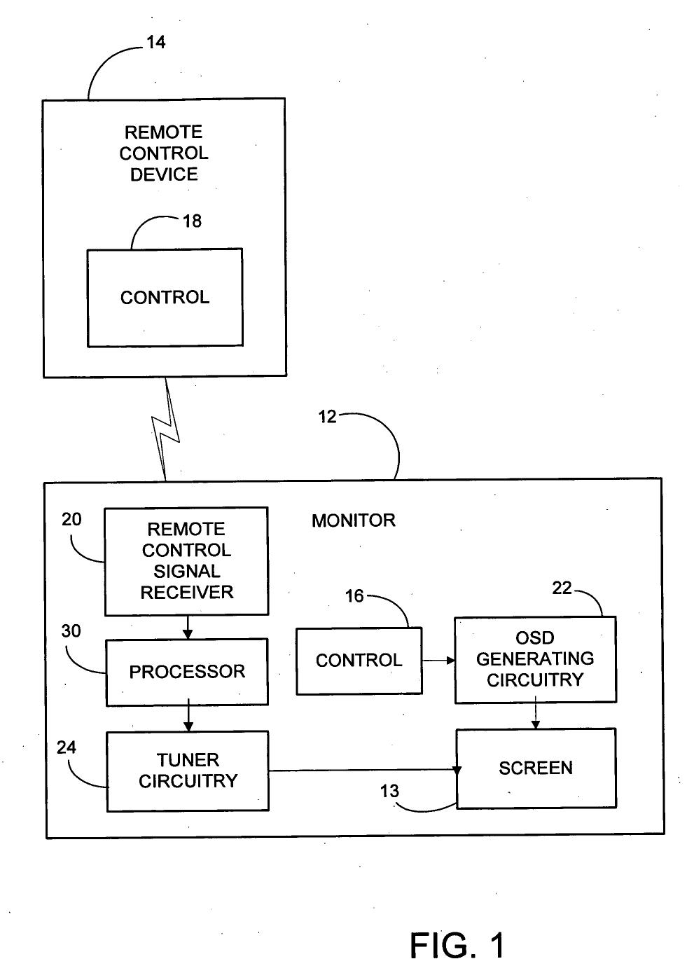

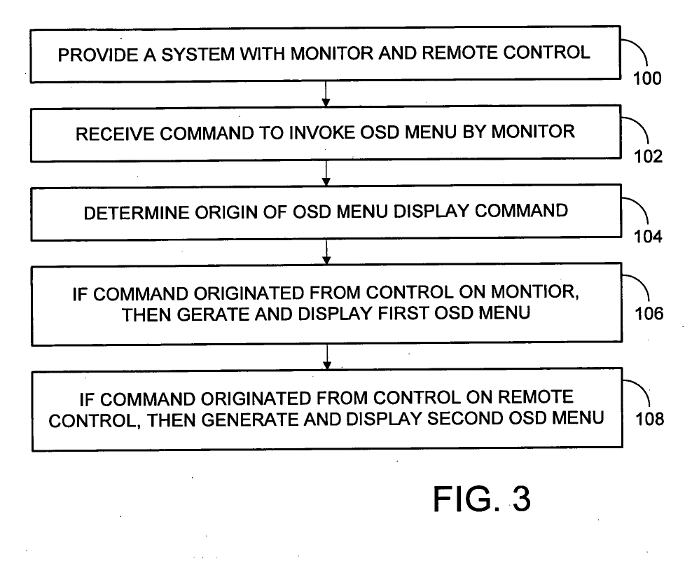

With reference now to the drawings, and in particular to FIGS. 1 through 7 thereof, a system and a method for determining a mode of viewing a display and adapting displayed elements to the mode of viewing of the present disclosure is generally designated by the reference numeral 10 in this description.

In one aspect of the disclosure, a system 10 includes a video display monitor 12 and a remote control device 14, with the remote control device being separate from and freely movable with respect to the monitor 12. The remote control device 14 is operable to transmit commands to the display monitor 12 from a distance from the location of the display monitor. The remote control device 14 is operationally connected or coupled to the display monitor 12, either by wire or in most preferred implementations, by wireless transmissions. The video display monitor 12 may include a display screen 13 on which various visually-perceptible images may be depicted. The video display monitor 12 may also include a suitable processor 30 for controlling the display operation of the monitor. It should be recognized that while the display is being called a monitor for the purposes of this description, the display monitor 12 may include additional functions to that typically found in a display monitor. These features may include, for example, television tuner circuitry.

The video display monitor 12 may include a control 16 for controlling various aspects of the operation of the monitor, such as, for example, for invoking an on-screen display (OSD) menu that lists various aspects or characteristics of the display on the screen of the monitor so that, for example, the various aspects or characteristics of the display can be controlled by the user using controls on the display monitor 12. Similarly, but not necessarily identically, the remote control device 14 may include a control 19 also for controlling various aspects of the operation of the monitor, including the function of invoking an on-screen display (OSD) menu that lists various aspects or characteristics of the display on the monitor so that, for example, the various aspects can be controlled by the user using the remote control device 14.

A remote control signal receiver 20 may be provided for receiving signals from the remote control 14. In some embodiments of the invention, the remote control device 14 controls the functions and display characteristics of the monitor 12 in a direct manner without relying upon the presence of, or communicating through, other devices (see FIG. 1). The remote control signal receiver 20 may be mounted on the housing of the display monitor 12 for receiving control signals from the remote control device 14. In such embodiments, the display monitor 12 may incorporate circuitry 22 for generating the on-screen display (OSD) menu that is operable, for example, by the control or controls 16 on the display monitor 12. The controls 16 on the display monitor 12 may be of any suitable type, and may provide different functionality in different modes (multi-functional). Additionally, tuner circuitry 24 may be incorporated into the monitor 12, and in those embodiments the monitor may be considered to be a television, although full or partial television functionality is not required for the implementation of the present invention.

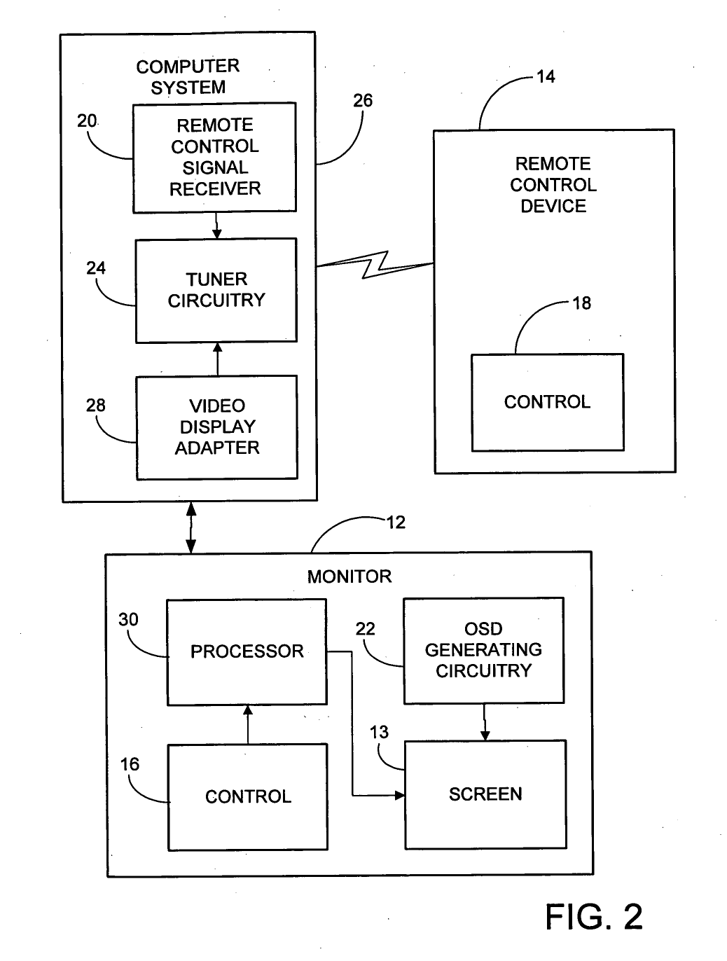

In other embodiments of the invention, the remote control device 14 may control another device and through that other device the remote control device may control various aspects of operation of the monitor 12 (see FIG. 2). For example, the remote control device 14 may control aspects of the operation of a freestanding tuner device or a computer system 26 that includes a video display adapter 28 or other component capable of generating and transmitting a video signal to the video display monitor 12. The computer system 26, or the video display adapter 28, may include a remote control signal receiver 20 that interacts and interfaces with the video display adapter 28. The video display adapter 20 of the computer system 18 may include functionality for generating an on-screen display (OSD) menu for display on the screen of the monitor 12.

In another aspect of the invention, a method of displaying information on a display monitor is disclosed. The method includes providing, or implementing a method of steps on, a system 10 that includes a video display monitor 12 and a remote control device 14. The monitor 12 may include a control 16 that is actuatable by a user, and the remote control device 14 may include a control 18 that is actuatable by the user (block 100). The control 16 of the display monitor 12 may be configured to invoke the display of an on-screen display (OSD) menu that may be utilized to control various aspects or characteristics or functions of the monitor 12. The control 18 of the remote control device 14 may also be configured to invoke the display of an on-screen display (OSD) menu, and in at least some embodiments of the system, the OSD menu invoked by the control 18 includes at least some of the same aspects and characteristics as the OSD menu invoked by the control 16.

The system 10 may receive a command or request to display an on-screen display (OSD) menu (block 102). The system, such as through the processor 30, may determine from what device the command to display the OSD menu originated (block 104). If the system 10 determines that the OSD menu command originated from an actuation of the control 16 on the monitor display 12, then the circuitry of the monitor may generate and display a first OSD menu (block 106). If the system 10 determines that the command originated from an actuation of the control 18 on the remote control device 14, then the circuitry of the display monitor 12 may generate and display a second OSD menu (block 108).

In various embodiments of the system, the first OSD menu and the second OSD menu are different, and the first and second menus may have, for example, different layouts. For example, the first and second OSD menus include text, and in some implementations of the system, the text of the first OSD menu and the text of the second OSD menu have a different displayed size on the display screen 13. Illustratively, the displayed size of the text utilized on the first OSD menu is smaller than the displayed size of the text utilized on the second OSD menu, which may enhance the visibility of the text on the second OSD menu invoked by the control 18 on the remote control device which is typically utilized when the user or viewer is located at greater distances than when the user invokes the OSD menu from the control 16 on the display monitor. As a result, readability of the text may be enhanced at greater distances of utilization.

As another example, the first OSD menu and the second OSD menu may include one or more icons or symbols, and in some implementations of the system, the displayed size of the icons in the first OSD menu and the second OSD menu are different. Illustratively, the displayed size of the icons on the first OSD menu is smaller than a displayed size of the icons on the second OSD menu. Similarly, this feature may enhance the visibility of the icons on the second OSD menu invoked by the control 18 on the remote control device which is typically utilized when the user or viewer is located at greater distances than when the user invokes the OSD menu from the control 16 on the display monitor. As a result, the ability to identify the icons may be enhanced at greater distances of utilization.

Further, as still another example, the first OSD menu and the second OSD menu may include graphics or graphical elements. In some implementations, the displayed size of the graphics on the first OSD menu and the second OSD menu are different. Illustratively, the displayed size of the graphics on the first OSD menu is smaller than the displayed size of the graphics of the second OSD menu.

Also, the first OSD menu and the second OSD menu may include a number of buttons that may be actuated or clicked upon to cause predetermined actions by the system 10. In some implementations of the system, the number of buttons displayed on the first OSD menu and the second OSD menu may be different. Illustratively, the number or quantity of buttons on the first OSD menu is less than the number of the buttons of the second OSD menu.

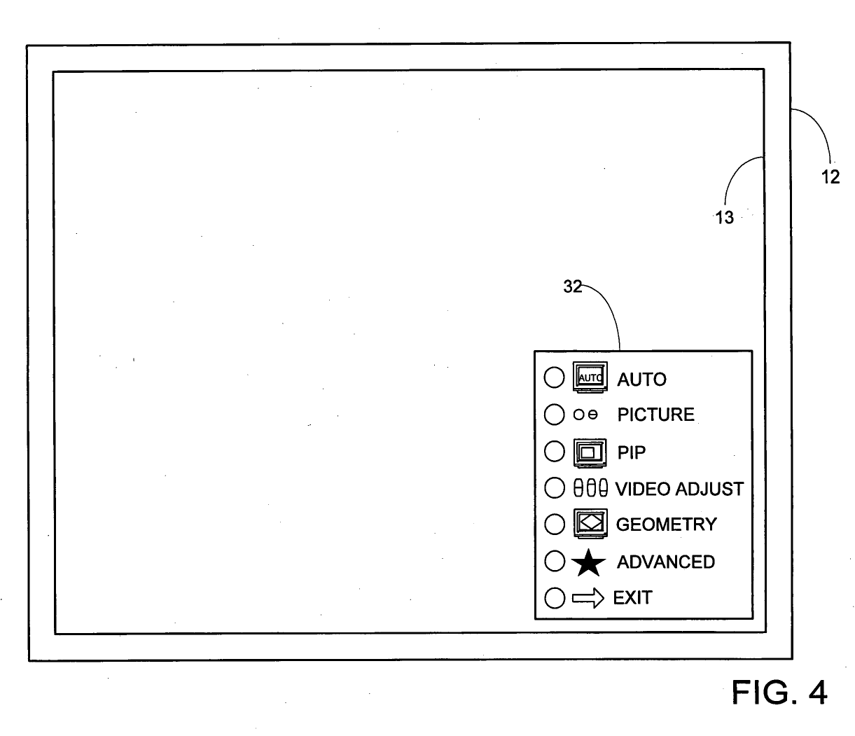

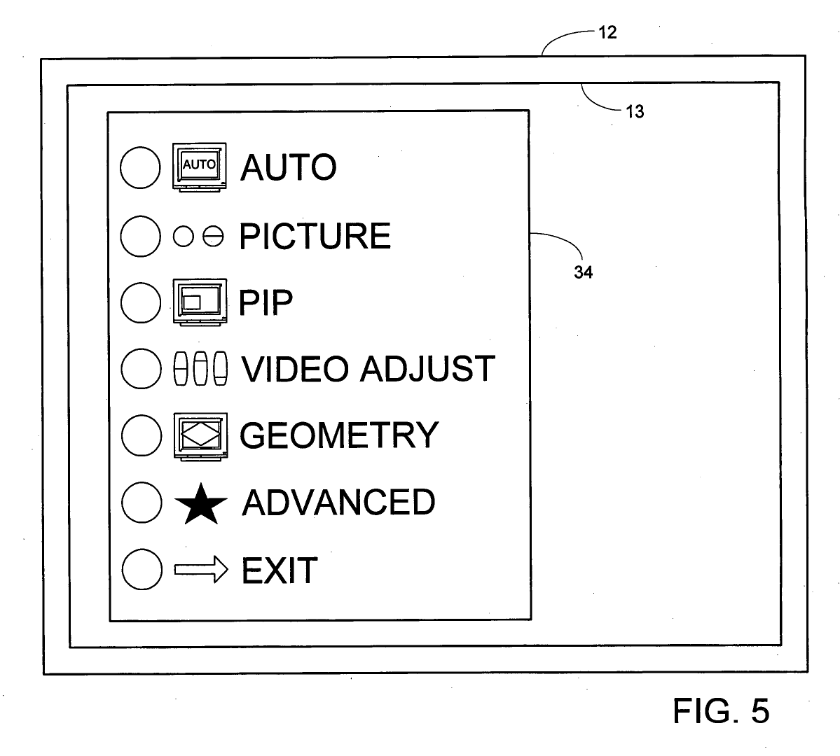

As shown in the illustrative examples of FIGS. 4 and 5, the first and second OSD menus may be highly similar (although not necessarily identical) in layout, with various elements being sized or scaled larger in the second OSD menu than the first OSD menu. This optional relationship between the first and second OSD menus facilitates familiarity by the user with the layout and classification of the different elements that make up the OSD menu.

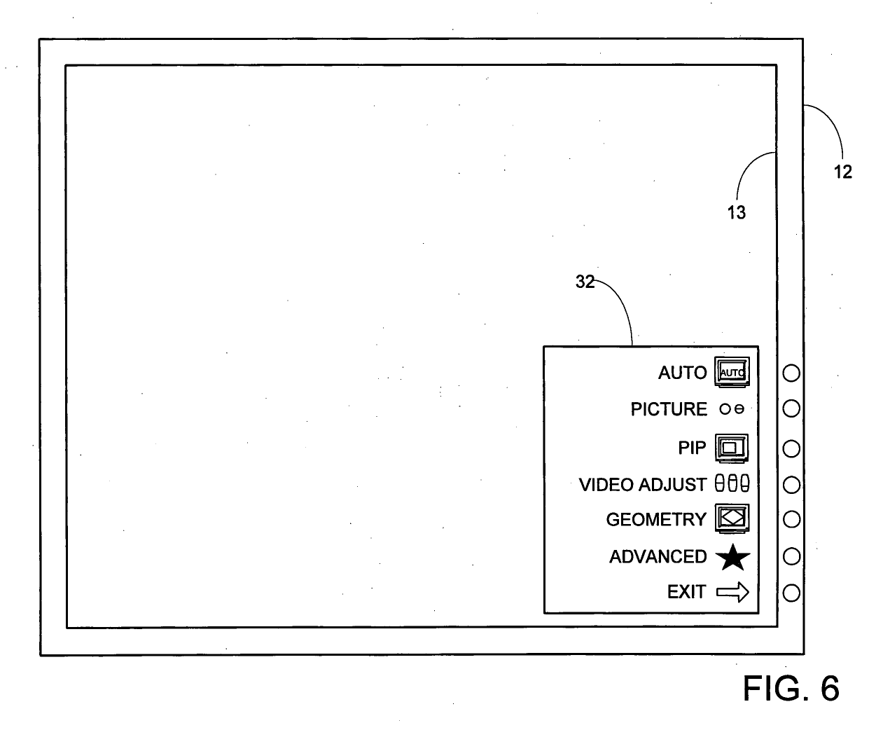

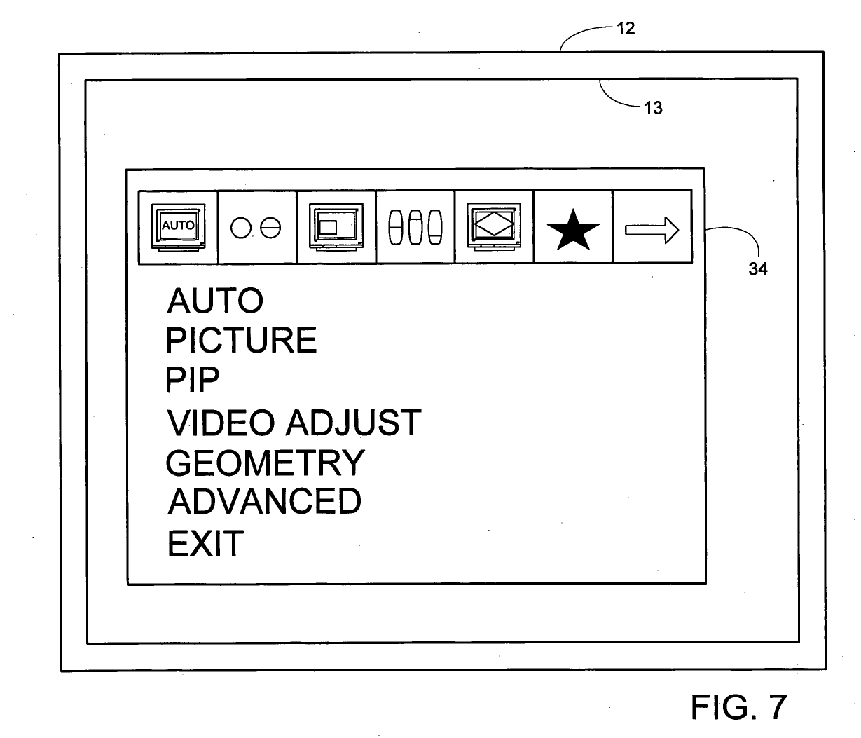

As shown in the illustrative examples of FIGS. 6 and 7, the first and second OSD menus may be may be different in layout or in the classification of the features in each menu and submenu. For example, in the first OSD menu shown in FIG. 6, buttons may be utilized and may be arranged along the side of the legends associated with the buttons. In the second OSD menu shown in FIG. 7, the button are not present, and icons may be arranged along the upper border area of the OSD menu. This optional relationship between the first and second OSD menus may facilitate different modes of navigation used for the different OSD menus. Illustratively, the first OSD menu may be navigated using buttons or touch sensitive areas that are positioned on the bezel of the housing of the display, and the positioning of the elements of the first OSD menu may be arranged to facilitate a spatial association between the buttons on the bezel and the menu elements on the display screen. In contrast, the second OSD menu may be navigated using a remote control and may thus be navigated using the up/down and left/right buttons on the remote control as well as an enter button, and thus may be more easily navigated if the icons are arranged in a line on the OSD menu window. Of course, other arrangements and relationships may be utilized and may become apparent to one of ordinary skill in the art in view of the foregoing disclosure.

While aspects of the system are disclosed as a method, i.e., in terms of flowcharts, it will be understood by a person of ordinary skill in the art that an apparatus, such as a conventional data processor, including a CPU, memory, I/O, program storage, a connecting bus, and other appropriate components, could be programmed or otherwise designed to facilitate the practice of the method of the invention. Such a processor would include appropriate program means for executing the method of the invention.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

I claim:

1. A method of displaying information on a video display monitor, comprising:
receiving a command to display an on-screen display (OSD) menu;
determining an origin of the command to display the OSD menu;
if the command originated from an actuation of a control on the video display monitor, then generating and displaying a first OSD menu; and
if the command originated from an actuation of a control on a remote control device, then generating and displaying a second OSD menu;
wherein the first OSD menu and the second OSD menu are different.

2. The method of claim 1 wherein the first OSD menu and the second OSD menu have different layouts.

3. The method of claim 1 wherein the first OSD menu and the second OSD menu include text, and a size of the text on the first OSD menu and the second OSD menu are different.

4. The method of claim 3 wherein the size of the text on the first OSD menu is smaller than the size of the text of the second OSD menu.

5. The method of claim 1 wherein the first OSD menu and the second OSD menu include icons, and a size of the icons on the first OSD menu and the second OSD menu are different.

6. The method of claim 5 wherein the size of the icons on the first OSD menu is smaller than the size of the icons of the second OSD menu.

7. The method of claim 1 wherein the first OSD menu and the second OSD menu include graphics, and a size of the graphics on the first OSD menu the second OSD menu are different.

8. The method of claim 7 wherein the size of the graphics on the first OSD menu is smaller than the size of the graphics of the second OSD menu.

9. The method of claim 1 wherein the first OSD menu and the second OSD menu include buttons, and a number of the buttons on the first OSD menu and the second OSD menu are different.

10. The method of claim 9 wherein the number of the buttons on the first OSD menu is less than the number of the buttons of the second OSD menu.

11. A system for displaying information on a video display monitor, comprising:
a video display monitor including a display screen, a memory configured to store firmware instructions, a processor for executing the firmware instructions; and
a set of instructions stored on the memory and configured to cause the processor to:
receive a command to display an on-screen display (OSD) menu;
determine an origin of the command to display the OSD menu;
if the command originated from an actuation of a control on the video display monitor, then generate and display a first OSD menu; and
if the command originated from an actuation of a control on a remote control device, then generate and display a second OSD menu;
wherein the first OSD menu and the second OSD menu are different.

12. The system of claim 11 wherein the first OSD menu and the second OSD menu have different layouts.

13. The system of claim 11 wherein the first OSD menu and the second OSD menu include text, and a size of the text on the first OSD menu and the second OSD menu are different.

14. The system of claim 13 wherein the size of the text on the first OSD menu is smaller than the size of the text of the second OSD menu.

15. The system of claim 11 wherein the first OSD menu and the second OSD menu include icons, and a size of the icons on the first OSD menu and the second OSD menu are different.

16. The system of claim 15 wherein the size of the icons on the first OSD menu is smaller than the size of the icons of the second OSD menu.

17. The system of claim 11 wherein the first OSD menu and the second OSD menu include graphics, and a size of the graphics on the first OSD menu the second OSD menu are different.

18. The system of claim 17 wherein the size of the graphics on the first OSD menu is smaller than the size of the graphics of the second OSD menu.

19. The system of claim 11 wherein the first OSD menu and the second OSD menu include buttons, and a number of the buttons on the first OSD menu and the second OSD menu are different.

20. The system of claim 19 wherein the number of the buttons on the first OSD menu is less than the number of the buttons of the second OSD menu.
